(19) United States
(12) Patent Application Publication
(10) Pub. No.: US 2010/0250763 A1
(43) Pub. Date: Sep. 30, 2010

(54) Method and Apparatus for Transmitting Information on Operation Points

(75) Inventor: Imed Bouazizi, Tampere (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/415,561

(22) Filed: Mar. 31, 2009

(51) Int. Cl. G06F 15/16

(52) U.S. Cl. 709/231

(57) ABSTRACT

In accordance with an example embodiment of the present invention, a method and apparatus are described for transmitting a scalable media stream comprising one or more layers corresponding to one or more operation points. Further, information about the one or more operation points is transmitted. A method and apparatus are shown for receiving a transmission of a scalable media stream comprising one or more layers corresponding to one or more operation points, Information about the one or more operation points is received, an operation point is selected, and the received transmission is filtered to receive a subset of the one or more layers corresponding to the selected operation point.

### TECHNICAL FIELD

The present application relates generally to transmitting information on operation points in a transmission of a media stream. The application further relates to signaling of operation points in a transmission of media streams comprising one or more layers.

### BACKGROUND

In a transmission of a media stream, the media stream may comprise one or more layers. For example, a video stream may comprise layers of different video quality. Scalable video coding (SVC) implements a layered coding scheme for encoding video sequences in order to achieve multiple operation points at decoding and playback stages in a receiving apparatus. In an example embodiment, a scalable video bit-stream is structured in a way that allows the extraction of one or more sub-streams. A sub-stream may be characterized by different properties of the media data transmitted in the layers. A sub-stream comprising one or more layers may represent a different operation point.

A layer may have properties such as quality, temporal resolution, spatial resolution, and the like. A scalable video bit-stream may comprise a base layer and one or more enhancement layers. Generally, the base layer carries a low quality video stream corresponding to a set of properties, for example for rendering a video content comprised in a media stream on an apparatus with a small video screen and/or a low processing power, such as a small handheld device like a mobile phone. One or more enhancement layers may carry information which may be used on an apparatus with a bigger display and/or more processing power. An enhancement layer improves one or more properties compared to the base layer. For example, an enhancement layer may provide an increased spatial resolution as compared to the base layer. Thus, a larger display of an apparatus may provide an enhanced video quality to the user by showing more details of a scene by supplying a higher spatial resolution. Another enhancement layer may provide an increased temporal resolution. Thus, more frames per second may be displayed allowing an apparatus to render motion more smoothly. Yet another enhancement layer may provide in increased quality by providing a higher color resolution and/or color depth. Thus, color contrast and rendition of color tones may be improved. A further enhancement layer may provide an increased visual quality by using a more robust coding scheme and/or different coding quality parameters. Thus, less coding artifacts are visible on the display of the apparatus, for example when the apparatus is used under conditions when the quality of the received signal that carries the transmission is low or varies significantly.

While a base layer that carries the low quality video stream requires a low bit rate, an enhancement layer may increase the bit rate and therefore increase the processing requirements of the receiving apparatus. An enhancement layer may be decoded independently, or it may be decoded in combination with the base layer and/or other enhancement layers.

The media stream may also comprise an audio stream comprising one or more layers. A base layer of an audio stream may comprise audio of a low quality, for example a low bandwidth, such as 4 kHz mono audio as used in some telephony systems, and a basic coding quality. Enhancement layers of the audio stream may comprise additional audio information providing a wider bandwidth, such as 16 kHz stereo audio or multichannel audio. Enhancement layers of the audio stream may also provide a more robust coding to provide an enhanced audio quality in situations when the quality of the received signal that carries the transmission is low or varies significantly.

### SUMMARY

Various aspects of examples of the invention are set out in the claims.

According to a first aspect of the present invention, a method is disclosed, comprising transmitting a scalable media stream comprising one or more layers corresponding to one or more operation points, and transmitting information related to the one or more operation points.

According to a second aspect of the present invention, a method is described comprising receiving at an apparatus a transmission of a scalable media stream comprising one or more layers corresponding to one or more operation points, and receiving information related to the one or more operation points. An operation point is selected, and the received transmission is filtered to receive a subset of the one or more layers corresponding to the selected operation point.

According to a third aspect of the present invention, an apparatus is shown comprising a transmitter configured to transmit a scalable media stream comprising one or more layers corresponding to one or more operation points, and a controller configured to provide information related to the one or more operation points. The transmitter is further configured to transmit the information related to the one or more operation points.

According to a fourth aspect of the present invention, an apparatus is disclosed comprising a receiver configured to receive a transmission of a scalable media stream comprising one or more layers corresponding to one or more operation points, wherein the receiver is further configured to receive information related to the one or more operation points. A controller of the apparatus is configured to select an operation point, and a filter of the apparatus is configured to filter the received transmission to receive a subset of the one or more layers corresponding to the selected operation point.

According to a fifth aspect of the present invention, a computer program, a computer program product and a computer-readable medium bearing computer program code embodied therein for use with a computer are disclosed, the computer program comprising code for transmitting a scalable media stream comprising one or more layers corresponding to one or more operation points, and code for transmitting information related to the one or more operation points.

According to a sixth aspect of the present invention, a computer program, a computer program product and a computer-readable medium bearing computer program code embodied therein for use with a computer are disclosed, the computer program comprising code for receiving at an apparatus a transmission of a scalable media stream comprising one or more layers corresponding to one or more operation points, wherein the transmission comprises information of the one or more operation points, code for selecting an operation point, and code for filtering the received transmission to receive a subset of the one or more layers corresponding to the selected operation point.

According to a seventh aspect of the present invention, a data structure for a service description file is described, the data structure comprising one or more operation points corresponding to one or more layers of a scalable media stream in a transmission.

### BRIEF DESCRIPTION OF THE DRAWINGS

For a more complete understanding of example embodiments of the present invention, reference is now made to the following descriptions taken in connection with the accompanying drawings in which:

FIG. 1 shows a transmission system according to an embodiment of the invention;

FIG. 2 shows an example embodiment of a transmission of physical layer frames of a media stream from a transmitter to a receiving apparatus;

FIG. 3 shows a flowchart of a method for transmitting packets of a scalable media stream comprising information related to operation points;

FIG. 4 shows a flowchart of a method for receiving packets of a scalable media stream comprising information related to operation points;

FIG. 5 shows an example embodiment of an apparatus configured to transmit packets of a scalable media stream comprising information related to operation points; and

FIG. 6 shows an example embodiment of an apparatus configured to receive packets of a scalable media stream comprising information related to operation points.

### DETAILED DESCRIPTION OF THE DRAWINGS

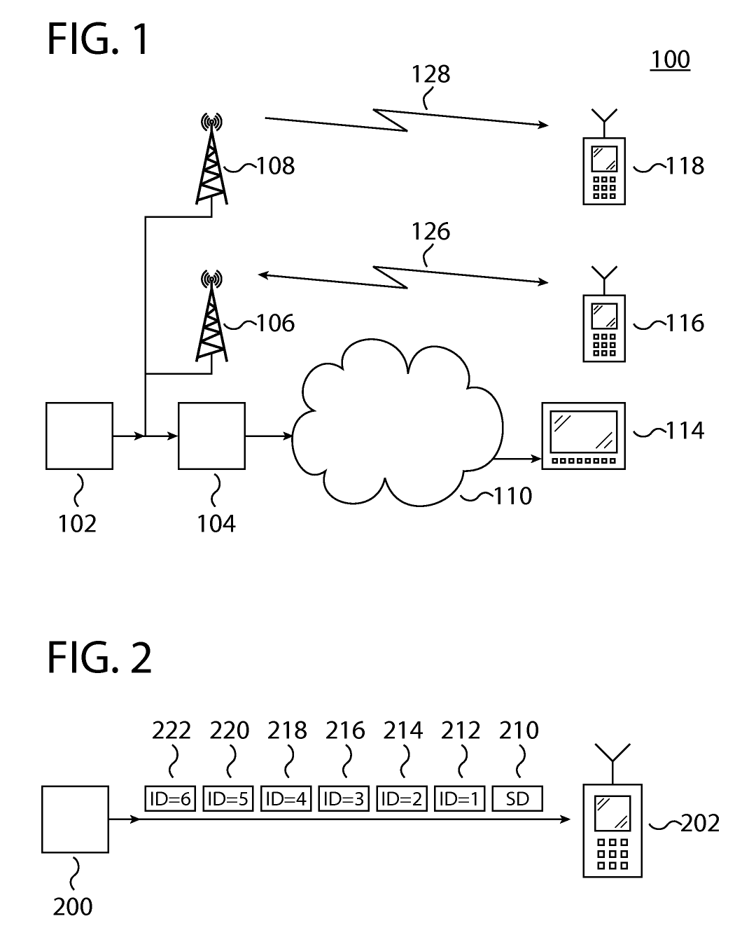

An example embodiment of the present invention and its potential advantages are understood by referring to FIGS. 1 through 6 of the drawings.

In a unicast, broadcast or multicast transmission, scalable video coding (SVC) may be used to address a variety of receivers with different capabilities efficiently. A receiver may subscribe to the layers of the media stream that correspond to an operation point configured at the apparatus, for example depending on the capabilities. In an example embodiment, an operation point is a set of features and/or properties related to a media stream. An operation point may be described in terms of the features such as video resolution, bit rate, frame rate, and/or the like. At a receiver, the features and/or properties of the media stream need to be matched with the capabilities of the receiver, such as a display resolution, a color bit depth, a maximum bit rate capability of a video processor, a total data processing capability reserved for media streaming, audio and video codecs installed, and/or the like. An operation point may also be selected at a receiver based at least in part on a user requirement within the limits of the processing and rendering capabilities of the apparatus. For example, a user may indicate a low, medium or high video quality and/or a low, medium or high audio quality. Especially in battery powered apparatuses there may be a trade-off between streaming quality and battery drain or battery life. Therefore, a user may configure the apparatus to use a low video quality and a medium audio quality. In this way, an operation point is selected that allows battery usage of the apparatus for a longer time as compared to a high video and a high audio quality. Thus, the apparatus may receive a subset of the layers of the transmission required to provide the media stream to the user at the selected operation point. The apparatus may or may not receive other layers that are not required.

In a transmission, SVC may be used to address the receiver capabilities by using an appropriate operation point depending on receiver capabilities and/or requirements. It may further be used to adapt the streaming rate to a varying channel capacity.

A scalable media stream may be transmitted using a real time transport protocol (RTP). The real time transport protocol stream may carry the one or more layers of the scalable media stream.

FIG. 1 shows a transmission system 100 according to an embodiment of the invention. A service provider 102 provides a media stream. The media stream may be transmitted over the internet 110 by an internet provider 104 using a cable connection to apparatus 114, for example a media player, a home media system, a computer, or the like. The media stream may also be transmitted by a transmitting station 106 to an apparatus 116 using a unicast transmission 126. The unicast transmission 126 may be bidirectional. The unicast transmission may be a cellular transmission such as a global system for mobile communications (GSM) transmission, a digital advanced mobile phone system (D-AMPS) transmission, code division multiple access (CDMA) transmission, wideband-CDMA (W-CDMA) transmission, a personal handy-phone system (PHS) transmission, a 3^{rd} generation systems like universal mobile telecommunications system (UMTS) transmission, a cordless transmission like a digital enhanced cordless telecommunication (DECT) transmission, and/or the like.

Further, the media stream from service provider 102 may be transmitted by a transmitting station 108 to an apparatus 118 using a broadcast or multicast transmission 128. The broadcast or multicast transmission may be a digital video broadcast (DVB) transmission according to the DVB-H (handheld), DVB-T (terrestrial), DVB-T2 (terrestrial 2, second generation), DVB-NGH (next generation handheld) standard, or according to any other digital broadcasting standard such as DMB (digital media broadcast), ISDB-T (Integrated Services Digital Broadcasting-Terrestrial), MediaFLO (forward link only), or the like.

Scalable video coding (SVC) may be used for streaming in a transmission. SVC provides enhancement layers carrying information to improve the quality of a media stream in addition to a base layer that provides a base quality, for example a low resolution video image and/or a low bandwidth mono audio stream.

Information related to the layers of a scalable media stream may be transmitted in a service description file, for example a file according to a session description protocol (SDP). The SDP is defined by the Internet Engineering Task Force (IETF) as RFC 4566 (“Request For Comments”, downloadable on http://www.ietf.org) and is included herein by reference. SDP is used to describe information on a session, for example media details, transport addresses, and other session description metadata. However, any other format to describe information of a session may be used.

A session description file may include information on layers. Information on layers may be marked with an information tag “i=” plus the layer information. For example, information on a layer may be tagged “i=baselayer” to indicate that information on a base layer is described. In another example, information a layer may be tagged “i=enhancementlayer” to indicate that information on an enhancement layer is described.

The following extract of an SDP file shows an example of information on layers in an SDP file, where layer information is marked with an i-tag (Example 1):

### EXAMPLE 1

m=video 10020 RTP/AVP 96
i=baselayer
c=IN IP4 232.199.2.0
b=AS:384
a=control:streamid=1
a=StreamId:integer;1
a=rtpmap:96 H264/90000
a=fmtp:96 profile-level-id=42E00C;sprop-parameter-sets=Z0LgDJZUCg/I,aM48gA==;packetization-mode=1
m=video 10020 RTP/AVP 96
i=enhancementlayer
c=IN IP4 232.199.2.1
b=AS:384
a=control:streamid=1
a=StreamId:integer;1
a=rtpmap:96 H264/90000
a=fmtp:96 profile-level-id=42E00C;sprop-parameter-sets=Z0LgDJZUCg/I,aM48gA==;packetization-mode=1

In another example, information on a layer may be tagged with an attribute “a=” tag as “a=videolayer:base” to indicate that information on a video base layer is described. In a further example, information on a layer may be tagged “a=videolayer:enhancement” to indicate that information on an enhancement layer is described. Similarly, an audio base layer may be tagged as “a=audiolayer:base” and an audio enhancement layer as “a=audiolayer:enhancement”.

The following extract of an SDP file shows an example of information on layers in an SDP file, where layer information is marked with an a-tag (Example 2):

### EXAMPLE 2

m=video 10020 RTP/AVP 96
c=IN IP4 232.199.2.0
b=AS:384
a=videolayer:base
a=control:streamid=1
a=StreamId:integer;1
a=rtpmap:96 H264/90000
a=fmtp:96 profile-level-id=42E00C;sprop-parameter-sets=Z0LgDJZUCg/I,aM48gA==;packetization-mode=1
m=video 10020 RTP/AVP 96
c=IN IP4 232.199.2.1
b=AS:384
a=videolayer:enhancement
a=control:streamid=1
a=StreamId:integer;1
a=rtpmap:96 H264/90000
a=fmtp:96 profile-level-id=42E00C;sprop-parameter-sets=Z0LgDJZUCg/I,aM48gA==;packetization-mode=1

In an example embodiment, several enhancement layers may be coded in a session description file as shown in examples 1 and 2.

In an example embodiment, one or more operation points are described in the session description file. An operation point may be described using the “a=” attribute tag. The “a=” tag may be followed by one or more parameters. These parameters may comprise a bit rate, a channel number, a quality indication, a resolution of the video stream, a frame rate of the video stream, a bandwidth of the uncoded or coded media stream, and/or the like. The parameters may use the Augmented Backus-Naur Form (ABNF) syntax of the form “rule=definition ; comment”.

In the following, examples of the parameters using the proposed syntax are shown:

OperationPoint=“a=operation-point:”format SP OPID SP*(bitrate/channels/quality/resolution/framerate/bandwidth);

Here, “SP” indicates any number of spaces, and “OPID” indicates an operation point identification (ID), for example a number which is unique for the transmission of the media stream.

OPID=“id=” 1*DIGIT

bitrate=“TIAS=” 1*DIGIT; bitrate in bits per second

channels=“channels=” 1*DIGIT

quality=“quality=” 1*DIGIT

resolution=“resolution=” Width “x” Height

Width=1*DIGIT

Height=1*DIGIT

framerate=1*DIGIT[“/” 1*DIGIT]

bandwidth=1*DIGIT

The following Example 3 shows an extract of a session description file defining 2 operation points for an audio stream and 4 operation points for a video stream:

### EXAMPLE 3

v=0
o=operator1 2890844526 2890844526 IN IP4 192.0.2.12
s=Multiple operation points
i=Scalable media with multiple operation points
c=IN IP4 192.0.2.12
t=0 0
m=audio 48000 RTP/AVPF 97
a=rtpmap:97 EV-VBR/32000/1
a=fmtp:97 layers=1,2,3,4,5
a=operation-point:97 ID=1 TIAS=16000 bandwidth=16000 channels=1
a=operation-point:97 ID=2 TIAS=32000 bandwidth=16000 channels=1
m=video 48002 RTP/AVP 98
a=rtpmap:98 H264/90000
a=fmtp:98 profile-level-id=4d400a; packetization-mode=0;
a=operation-point:98 ID=3 TIAS=128000 resolution=176×144 framerate=15 quality=0
a=operation-point:98 ID=4 TIAS=256000 resolution=176×144 framerate=15 quality=1
a=operation-point:98 ID=5 TIAS=512000 resolution=352×288 framerate=30 quality=0
a=operation-point:98 ID=6 TIAS=768000 resolution=352×288 framerate=30 quality=1

Example 3 shows multiple operation points for the audio and video streams that are declared as part of a single media stream. The ID-field may be used to select or change the operation point in a streaming session.

In an example embodiment, a receiver receives a session description file as shown in Example 3, comprising information related to one or more operation points. The receiver may be an apparatus with a display of 240×160 pixels and a processor capable of decoding video streams at a bit rate of 128000 bit/s with a frame rate of 15 frames/s. The apparatus may also provide audio decoding capability of a bit rate of 16000 bit/s. The apparatus may select an operation point. The selection of an operation point may be based at least in part on the capabilities of the apparatus, a user requirement or user input, and/or the received information related to the one or more operation points. For example, the receiver selects the first audio operation point from Example 3 indicating a bit rate of 16000 bit/s. The receiver further selects the first video operation point indicating a bit rate of 128000 bit/s of a video stream that provides a video of 176×144 pixels and a frame rate of 15 frames/s. For the selection of the operation point, the apparatus may check that the decoding and display properties allow the audio and video streams to be decoded and provided to the user. The apparatus will then filter the incoming media stream to receive an audio stream of the audio base layer with an ID=1 and a video stream based on the video base layer with stream ID=3.

FIG. 2 shows an example embodiment of a transmission of packets of a media stream from a transmitting apparatus 200 to a receiving apparatus 202. In an example embodiment, the packets may be physical layer frames of a DVB system. The transmission comprises packets 210, 212, 214, 216, 218, 220 and 222. Packet 210 comprises a session description file, for example a file carrying information of one or more operations point as shown in Example 3. Packet 212 carries an identifier ID=1. From the information contained in the service description file, the receiving apparatus 202 identifies packet 212 to carry a base layer of an audio stream with a bit rate of 16000 bit/s. The receiving apparatus 202 further identifies packet 214 carrying an identifier ID=2 to comprise an audio enhancement layer of the audio stream for a cumulative bit rate of 32000, in accordance with Example 3. Likewise, receiving apparatus 202 identifies packet 216 with ID=3 to comprise a base layer of a video stream with a bit rate of 128000 bit/s for a resolution of 176×144 pixel at a frame rate of 15 frames/s and a low quality (quality=0), packet 218 with ID=4 to carry an enhancement layer of the video stream with a cumulative bit rate of 256000 bit/s for a resolution of 176×144 pixel at a frame rate of 15 frames/s and a high quality (quality=1), packet 220 with ID=5 to carry an enhancement layer of the video stream with a cumulative bit rate of 512000 bit/s for a resolution of 352×288 pixels at a frame rate of 30 frames/s and a low quality (quality=0), and packet 222 with ID=6 to carry a further enhancement layer of the video stream with a cumulative bit rate of 768000 bit/s for a resolution of 352×288 pixels at a frame rate of 30 frames/s and a high quality (quality=1).

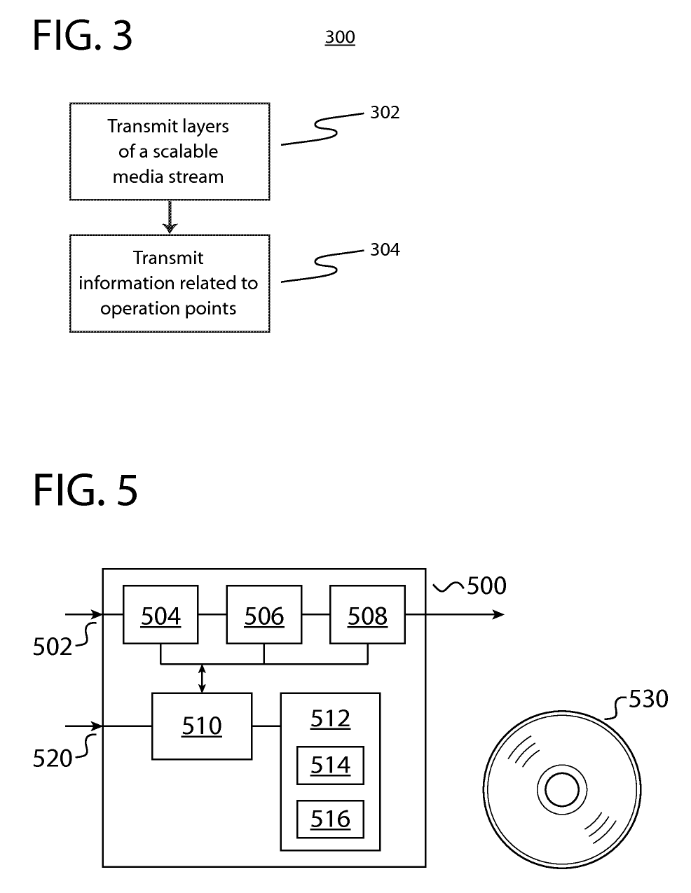

FIG. 3 shows a flowchart of a method 300 for transmitting a scalable media stream comprising information related to operation points. At block 302, a scalable media stream is transmitted comprising one or more layers corresponding to one or more operation points, for example from internet provider 104 or transmitting station 106, 108 of FIG. 1. The one or more layers of the scalable media stream may be transmitted in packets or physical layer frames, as shown in FIG. 2. At block 304, information related to the one or more operation points is transmitted. Characteristics of an operation point may be transmitted in a session description file. Characteristics of the one or more operation points may comprise a resulting bit rate of at least one layer of the one or more layers of the scalable media stream. In an example embodiment, characteristics of the one or more operation points may further comprise a channel number, a quality indication, a resolution of an image, a width of an image, a height of an image, a frame rate of a video stream, a bandwidth of a provided coded or uncoded signal, and/or the like. By transmitting information related to operation points, a receiver may be enabled to select an operation point without analyzing the layers in the media stream.

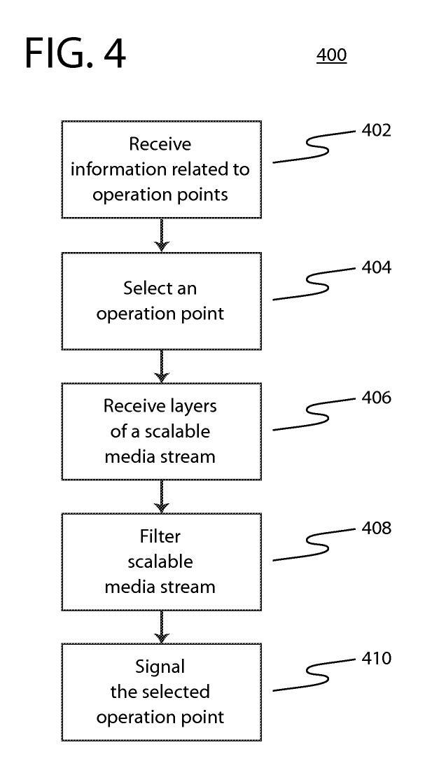

FIG. 4 shows a flowchart of a method 400 for receiving and filtering packets of a scalable media stream comprising information related to operation points. At block 402, information related to operation points is received, for example at apparatus 114, 116, 118 of FIG. 1 or apparatus 202 of FIG. 2. Information related to operation points may be received in a session description file.

At block 404, an operation point is selected. Selection of the operation point may be based at least in part on the received information related to operation points. Capabilities of the apparatus may be considered when selecting the operation point, for example a processing capability, a video rendering capability, an audio rendering capability and/or the like. A processing capability may indicate at what data rate an incoming media stream may be processed. A video rendering capability may indicate a display size and/or resolution, a frame rate, a color depth, one or more video codecs that are supported, and/or further properties of a video component or video components of the apparatus. An audio rendering capability may indicate an audio bit rate, an audio bandwidth, a number of audio channels, one or more audio codecs that are supported and/or further properties of an audio component or audio components of the apparatus.

Further, a user preference and/or a user selection may be considered for the selection of the operation point. For example, a user preference and/or user selection may indicate that a medium video quality should be used. A user preference and/or user selection may further indicate that a power saving is preferred to a high quality of the video and audio reproduction. Thus, an operation point may be selected that provides a medium quality by using a subset of the enhancement channels.

At block 406, a transmission of a scalable media stream comprising one or more layers corresponding to the one or more operation points is received. At block 408, the transmission of the scalable media stream is filtered to receive a subset of the one or more layers corresponding to the selected operation point. Packets corresponding to the selected operation point are extracted while other packets are discarded. For example, packets 212 and 216 of FIG. 2 (in accordance with the extract of a session description file of Example 3) may be selected to provide the baselayer of an audio and video stream, respectively, for example in an apparatus with low capabilities, while packets 214, 218, 220, and 222 may be discarded.

The apparatus may define the operation point before reception of a media stream or change the operation point at any time during reception of the media stream. In an example embodiment, information related to the one or more operation points is received after reception of the scalable media stream has started. Thus, the operation point may be selected after reception of the information related to the operation points. In another example embodiment, the apparatus detects a low battery. Battery life may be stretched by receiving fewer layers of the media stream and rendering the media stream at a quality lower than before. Thus, the operation point may be changed while a reception of the media stream is ongoing.

In an example embodiment, at block 410 the apparatus transmits an indication of the selected operation point, for example to the transmitting apparatus from which the scalable media stream was received, such as internet provider 104, transmitting station 106, 108 of FIG. 1 or transmitting apparatus 200 of FIG. 2. For example, the selected operation point may be signaled using a real time streaming protocol (RTSP). The transmitting apparatus may decide to transmit only a subset of the one or more layers in the media stream corresponding to the selected operation point. The transmitting apparatus may base the decision at least in part on a determination whether other receivers are also receiving the media stream.

In an example embodiment, a change of the set of layers for transmission in the media stream, for example a stream according to a real time transport protocol (RTP), may affect a bit rate of the transmission stream. It may or may not affect other parameters of the media stream.

In an example embodiment, the media stream is sent in a unicast transmission and the media stream is not received by other receivers. The transmitter may therefore determine to transmit a subset of the layers corresponding to the operation point selected by the receiver.

In a further embodiment, the media stream is sent in a multicast or broadcast transmission. At least one receiver has signaled an operation point requiring layers with ID=1 and ID=3. At least one other receiver has signaled an operation point requiring layers with ID=1, ID=2, ID=3 and ID=4. The transmitter may therefore determine to send layers with ID=1 to 4 in the media stream, but not to send layers with ID=5 and ID=6. Therefore, the receivers may receive the layers corresponding to their respective operation points.

The selected operation point may be signaled before reception of the media stream begins or during reception of the media stream. The transmitter may therefore adapt the number of layers included in the transmission at any time during the transmission of the media stream.

In an example embodiment, an initial operation point may be signaled by a “SETUP” method for a media stream. The selected operation point may be signaled in a header field of the setup method. The operation point may be indicated in the header field according to the following ABNF syntax: Operation-point=“Operation-Point:” SP ID. Examples 4a and 4b show an example header field of the setup method. An answer from the transmitter may acknowledge the selected operation point.

### EXAMPLE 4a

### Operation Point Selection by the Receiver

SETUP rtsp://mediaserver.com/movie.test/streamID=0 RTSP/1.0
CSeq: 2
Transport: RTP/AVP/UDP;unicast;client_port=3456-3457
Operation-Point: 4
User-Agent: 3GPP PSS Client/1.1b2

### EXAMPLE 4b

### Operation Point Acknowledgement by the Transmitter

RTSP/1.0 200 OK
CSeq: 2
Transport: RTP/AVP/UDP;unicast;client_port=3456-3457; server_port=5678-5679
Operation-Point: 4
Session: 834876

Example 4a shows a selection of operation point “4”, for example operation point 4 of a video stream described in the session description file of Example 3. Example 4b shows the acknowledgement by the transmitter of operation point “4”. In an example embodiment, an operation point with an ID=“4” may indicate that all layers with an ID smaller or equal to “4” are requested, for example layers 1 to 4 from Example 3. In another example embodiment, an operation point with an ID=“4” may indicate that the base layers and the enhancement layer with ID=“4” are requested, for example layers 1, 3 and 4 from Example 3. Other conventions of mapping the layers to operation points may be possible.

For signaling a selected operation point during reception of the media stream a “SET_PARAMETER” method may be used. Examples 5a and 5b show an example method for changing an operation point by a request and a confirmation. As the operation point applies to a specific media stream, a uniform resource locator (URL) is provided to identify the media stream.

### EXAMPLE 5a

### Request by Receiver

SET_PARAMETER rtsp://mediaserv.com/movie.test/ RTSP/1.0
CSeq: 8
Session: dfhyrio9011k
User-Agent: TheStreamClient/1.1b2
Operation-Point: url=“rtsp://mediaserv.com/movie.test/streamID=0”;ID=2

### EXAMPLE 5b

### Confirmation by Transmitter

RTSP/1.0 200 OK
CSeq: 8
Session: 87348
Operation-Point: url=“rtsp://mediaserv.com/movie.test/streamID=0”;ID=2

The operation point is changed to “ID=2”, indicating that the enhancement layer of the audio stream with a bit rate of 32000 bit/s of Example 3 shall be used.

FIG. 5 shows an example embodiment of an apparatus 500 configured to transmit packets of a media stream, for example internet provider 104 or transmitting station 106, 108 of FIG. 1, or apparatus 200 of FIG. 2. Apparatus 500 receives a media stream at port 502, for example from service provider 102 of FIG. 1. Layered coder 504 produces base and enhancement layers of the media stream which are cast into transmission packets at packetizer 506. Transmission packets are forwarded to transmitter 508 which prepares packets for transmission, for example over the air transmission or cable transmission. Controller 510 controls the operation of the layered coder 504, packetizer 506 and transmitter 508. For example, controller 510 defines the properties of the layers, such as the bit rate, audio bandwidth, number of audio channels, audio codecs, video resolution, video frame rate, video codecs, and/or the like. Controller 510 provides information related to the layers to packetizer 506. Controller 510 also assembles a session description file including information on the layers and the operation points, for example a session description file in accordance with a session description protocol (SDP) as shown in Example 3. Packetizer 506 may put the session description file in a packet for transmission, such as packet or physical layer frame 210 of FIG. 2.

In an example embodiment, apparatus 500 may receive signaling information from one or more receiving apparatuses on port 520. Controller 510 may instruct layered coder 504 and/or packetizer 506 to prepare packets only for layers requested in the signaling information.

Apparatus 500 may further comprise memory 510 storing software for running apparatus 500. For example, software instructions for running the controller 510 may be stored in one or more areas 514 and 516 of memory 512. Memory 512 may comprise volatile memory, for example random access memory (RAM), and non volatile memory, for example read only memory (ROM), FLASH memory, or the like. Memory 512 may comprise one or more memory components. Memory 512 may also be embedded with processor 510. Software comprising data and instructions to run apparatus 500 may also be loaded into memory 512 from an external source. For example, software may be stored on an external memory like a memory stick comprising one or more FLASH memory components, a compact disc (CD), a digital versatile disc (DVD) 530, and/or the like. Software or software components for running apparatus 500 may also be loaded from a remote server, for example through the internet.

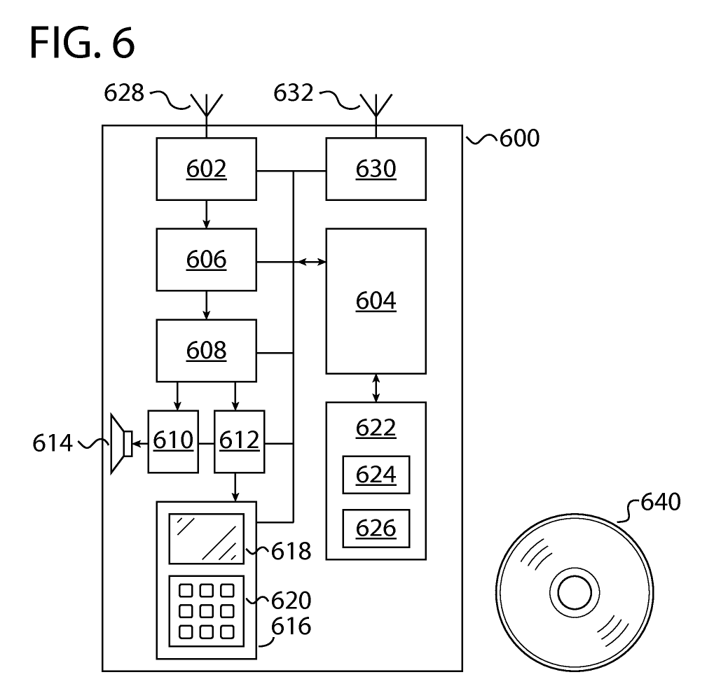

FIG. 6 shows an example embodiment of an apparatus 600 configured to receive packets of a media stream, for example apparatus 202 of FIG. 2. Apparatus 600 may be a mobile apparatus, for example a mobile phone. Apparatus 600 comprises a receiver 602 configured to receive a transmission of a scalable media stream comprising one or more layers corresponding to one or more operation points. In an example embodiment, the transmission may be received through antenna 628. In another example embodiment, the transmission may be received through a cable connection. Incoming packets of the media stream are forwarded to packet filter 606. Packet filter 606 may identify packets containing a session description file, for example packet 210 of FIG. 2. Packet filter 606 forwards these packets to controller 604 of apparatus 600. Controller 604 is configured to select an operation point. The selection of an operation point may be based at least in part on capabilities of apparatus 600, such as video and audio rendering capabilities, and/or on a user input.

For example audio decoder 610 may be capable of decoding a low quality audio stream with a bit rate of 16000 bit/s. Further, apparatus 600 may have a user interface 616 with a display 618 providing a resolution of 300×200 pixel and be capable of rendering a video stream with a frame rate of 15 frames/s. Video decoder 612 may be capable of decoding an incoming video bit stream of a bit rate of 128000 bit/s. Therefore, controller 604 may select an operation point with the base audio layer (ID=1) and the base video layer (ID=3) of Example 3. Controller 604 may indicate the selected operation point to filter 606. In an example embodiment, controller 604 may indicate the ID values of packets containing the layers required for the selected operation point. Filter 606 filters packets with ID=1 and ID=3 from the received media stream. Filtered packets are forwarded to packet decapsulator block 608 which extracts audio packets for audio decoder 610 and video packets for video decoder 612. Audio may be provided through loudspeaker 614. In an example embodiment, audio may also be provided to a wired or wireless headset. Video content may be put out on display 618 of user interface 616.

In another example embodiment, audio decoder 610 may be capable of decoding a high quality audio stream of a bit rate of 32000 bit/s. Video decoder 612 may be capable of decoding an incoming bit stream of a bit rate of 768000 bit/s (high quality) at a frame rate of 30 frames/s. Display 618 may further have a resolution of 600×400 pixel. Therefore, controller 604 selects an operation point with the base audio layer (ID=1), the enhancement audio layer (ID=2), the base video layer (ID=3) and a set of video enhancement layers to provide video of a bit rate of 768000 bit/s and a resolution of 352×288 pixel at a frame rate of 30 frames/s (ID=4, ID=5, ID=6).

In a further example embodiment, apparatus 600 may have the same capabilities as just described. Energy for apparatus 600 may be provided by a battery. Apparatus 600 may detect a user preference or receive a user input, for example on keyboard 620 of user interface 616, to use only the low quality (quality=0) stream in order to reduce power consumption and increase battery life. Therefore, audio layers with ID=1 and ID=2 and video layers with ID=3, ID=4 and ID=5 are received. However, video enhancement layer with ID=6 is not received.

In an example embodiment, apparatus 600 comprises a transmitter 630 configured to signal the selected operation point, for example to apparatus 500 of FIG. 5. The selected operation point may be signaled using a real time streaming protocol (RTSP). Transmitter 630 may be connected to an antenna 632 for transmitting the operation point. In an example embodiment, receiver 602 and transmitter 630 may use the same antenna. In a further example embodiment, transmitter 632 may be connected to the internet through a cable connection.

Software for running apparatus 600 may be stored in a storage or memory 622. For example, software instructions for running the controller 604 may be stored in one or more areas 624 and 626 of memory 622. Memory 622 may comprise volatile memory, for example random access memory (RAM), and non volatile memory, for example read only memory (ROM), FLASH memory, or the like. Memory 622 may comprise one or more memory components. Memory 622 may also be embedded with processor 604. Software comprising data and instructions to run apparatus 600 may also be loaded into memory 622 from an external source. For example, software may be stored on an external memory like a memory stick comprising one or more FLASH memory components, a compact disc (CD), a digital versatile disc (DVD) 640, or the like. Software or software components for running apparatus 600 may also be loaded from a remote server, for example through the internet.

Without in any way limiting the scope, interpretation, or application of the claims appearing below, a technical effect of one or more of the example embodiments disclosed herein may be that power may be saved in an apparatus receiving a media stream by identifying layers that are required to render the media stream at a selected operation point. Another technical effect of one or more of the example embodiments disclosed herein may be that properties of one or more operation points of the layered transmission may be derived from a single source: the session description file. Another technical effect of one or more of the example embodiments disclosed herein may be that switching between operation points in a receiver may be performed without reverting to switching a media stream or adding one or more new media streams. Another technical effect of one or more of the example embodiments disclosed herein may be that an operation point may be selected during setup of a media stream.

Embodiments of the present invention may be implemented in software, hardware, application logic, an application specific integrated circuit (ASIC) or a combination of software, hardware and application logic. The software, application logic and/or hardware may reside on an apparatus or an accessory to the apparatus. For example, the receiver may reside on a mobile TV accessory connected to a mobile phone. If desired, part of the software, application logic and/or hardware may reside on an apparatus, part of the software, application logic and/or hardware may reside on an accessory. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device. A computer-readable medium may comprise a computer-readable storage medium that may be any media or means that can contain or store the instructions for use by or in connection with an instruction execution system, apparatus, or device.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. A method, comprising:
transmitting a scalable media stream comprising one or more layers corresponding to one or more operation points; and
transmitting information related to the one or more operation points.

2. The method of claim 1, wherein characteristics of the one or more operation points comprise a resulting bit rate of at least one layer of the one or more layers of the scalable media stream.

3. The method claim 1, wherein the scalable media stream comprises one or more layers of a video stream, and wherein characteristics of the one or more operation points of the video stream comprise at least one of a spatial resolution, a temporal resolution, and a quality level.

4. The method claim 1, wherein the scalable media stream comprises one or more layers of an audio stream, and wherein characteristics of the one or more operation points of the audio stream comprise at least one of a coded bandwidth and a number of channels.

5. The method claim 1, further comprising:
receiving an indication of a selected operation point using a real time streaming protocol.

6. The method of claim 5, further comprising:
transmitting only a subset of the one or more layers corresponding to the selected operation point.

7. The method claim 1, wherein the information related to the one or more operation points is transmitted in a session description file.

8. The method of claim 7, wherein the session description file uses a syntax of a session description protocol.

9. The method claim 1, wherein the transmission of the scalable media stream is one of a broadcast transmission, a multicast transmission, and a unicast transmission.

10-19. (canceled)

20. An apparatus comprising:
a receiver configured to receive a transmission of a scalable media stream comprising one or more layers corresponding to one or more operation points;
wherein the receiver is further configured to receive information related to the one or more operation points;
a controller configured to select an operation point; and
a filter configured to filter the received transmission to receive a subset of the one or more layers corresponding to the selected operation point.

21. The apparatus of claim 20, wherein the scalable media stream comprises at least one of a video stream and an audio stream.

22. The apparatus of claim 20, wherein the information related to the one or more operation points is received in a session description file.

23. The apparatus of claim 20, further comprising:
a transmitter configured to transmit an indication of the selected operation point using a real time streaming protocol.

24. The apparatus of claim 20, wherein the receiver is one of a broadcast receiver, a multicast receiver, and a unicast receiver.

25. (canceled)

26. A computer program product comprising a computer-readable medium bearing computer program code embodied therein for use with a computer, the computer program code comprising:
code for receiving at an apparatus a transmission of a scalable media stream comprising one or more layers corresponding to one or more operation points;
code for receiving information related to the one or more operation points;
code for selecting an operation point; and
code for filtering the received transmission to receive a subset of the one or more layers corresponding to the selected operation point.

27. A computer readable medium containing a data structure for a service description file, the data structure comprising one or more operation points corresponding to one or more layers of a scalable media stream in a transmission.
